(19) United States
(12) Patent Application Publication
(10) Pub. No.: US 2015/0134538 A1
(43) Pub. Date: May 14, 2015

(54) APPLICATION FOR USING MOBILE COMMUNICATION TERMINAL AS PAYMENT TERMINAL, AND APPLICATION SERVICE PROVIDER SYSTEM AND METHOD

(71) Applicant: Ju Han Kim, Bucheon-si (KR)

(72) Inventor: Ju Han Kim, Bucheon-si (KR)

(21) Appl. No.: 14/401,839

(22) PCT Filed: May 21, 2013
(86) PCT No.: PCT/KR2013/004460

§ 371 Date: Nov. 18, 2014

(30) Foreign Application Priority Data
May 21, 2012 (KR) 10-2012-0053414

(51) Int. Cl. G06Q 20/32; G06Q 20/34; G06Q 20/38

(52) U.S. Cl. CPC G06Q 20/3227; G06Q 20/3829; G06Q 20/34; G06Q 20/385
USPC 705/71

(57) ABSTRACT

A franchise Application Service Provider (ASP) server is disclosed. The franchise ASP server includes a token generating function unit that generates a token on the basis of transaction-related information included in a payment request upon receiving the payment request from a payment terminal, and generates a net key for payment on the basis of the generated token and a franchise identifier, a token processing unit that processes the generated token in conjunction with a smart safe for receiving the net key for payment from a buyer terminal having received the net key for payment, and a token confirmation unit that receives a confirmation request of the token from the payment terminal and confirms whether the token has been processed.

### TECHNICAL FIELD

The present invention relates to a payment service using a mobile communication terminal, and more particularly, to a payment application of a mobile communication terminal in which a card payment may be processed without a card reader in conjunction with payment services using payment information including personal information and card information of a mobile communication subscriber which are stored and managed by a mobile communication company, and a franchise Application Service Provider (ASP) system and method.

### BACKGROUND ART

Due to the spread of mobile communication terminals to which cameras are attached, two-dimensional (2D) barcodes such as quick response (QR) codes can be read by the mobile communication terminals by executing an application for scanning such barcodes.

In addition, due to the recent spread of mobile communication terminals equipped with Bluetooth and/or near-field communication (NFC), which are world standards in short-range wireless communication, data can be transmitted and received between mobile communication terminals through short-range wireless communication.

Due to the development of authentication using mobile communication terminals, membership registration, applications for payment services, prepaid and postpaid payment systems, and the like, payments can be processed through the mobile communication terminal.

However, for the purpose of the authentication and payment using the related art, a franchise Application Service Provider (ASP) server or system is required, but it may be difficult for small businesses to construct franchise ASP servers or systems on their own. Thus, there are demands for more economical and convenient payment methods and systems.

### DISCLOSURE

### Technical Problem

The present invention is directed to providing a franchise Application Service Provider (ASP) system. In addition, the present invention is directed to providing a payment system that can be used in mobile shops only by installing an application in a smart phone or a tablet PC.

### Technical Solution

One aspect of the present invention provides a franchise Application Service Provider (ASP) server including: a token generating function unit that generates a token on the basis of transaction-related information included in a payment request upon receiving the payment request from a payment terminal, and generates a net key for payment on the basis of the generated token and a franchise identifier; a token processing unit that processes the generated token in conjunction with a smart safe for receiving the net key for payment from a buyer terminal having received the net key for payment; and a token confirmation unit that receives a confirmation request of the token from the payment terminal and confirms whether the token has been processed.

Here, the franchise ASP server may further include: a database that stores at least one of ASP contract information, payment terminal information, token information, and ASP transaction information.

Also, the net key for payment may be transmitted to the payment terminal from the franchise ASP server, and may be converted into a quick response (QR) code by the payment terminal.

Also, the payment terminal may be extracted by the buyer terminal from the QR code, and transmitted to the smart safe.

Also, the smart safe may store personal authentication information and payment information of a buyer.

Another aspect of the present invention provides an online payment method including: requesting, by a payment terminal, payment from a web server; requesting, by the web server, a net key for payment based on a site identifier and payment information from a franchise ASP server; generating, by the franchise ASP server, a token corresponding to the request for payment; generating, by the franchise ASP server, the net key for payment based on the generated token and a franchise identifier; transmitting, by the franchise ASP server, the generated token and the net key for payment to the web server; generating, by the web server, a QR code image based on the received net key for payment; and creating, by the web server, a screen including the QR code image, and transmitting the created screen to a client terminal.

Here, the online payment method may further include: extracting, by a buyer terminal, the net key for payment from the QR code image displayed on the payment terminal, and transmitting the extracted net key for payment to a smart safe; and processing, by the smart safe, the requested payment in conjunction with the franchise ASP server.

Also, the online payment method may further include: periodically confirming, by the web server, whether the token has been processed according to a token monitoring request of the payment terminal; and notifying, by the web server, the payment terminal that the token has been completely processed when the token has been completely processed.

Also, the smart safe may store personal authentication information and payment information of a buyer.

Also, a predetermined validity time of the token may be designated, and the token may be valid only when the token is processed within the predetermined validity time.

Still another aspect of the present invention provides an offline payment method including: transmitting, by a payment terminal, a payment amount and payment-related information to a franchise ASP server to request payment; generating, by the franchise ASP server, a token corresponding to the payment amount and the payment-related information; generating, by the franchise ASP server, a net key for payment based on the generated token and a franchise identifier, and transmitting the net key for payment to the payment terminal; transmitting, by the payment terminal, the received net key for payment to a buyer terminal;

processing, by the franchise ASP server, the requested payment in conjunction with a smart safe for receiving the net key for payment from the buyer terminal having received the net key for payment; and transmitting, by the franchise ASP server, a result of the processed payment to the payment terminal.

Here, the offline payment method may further include: requesting, by the payment terminal, initialization of the payment terminal from the franchise ASP server when the payment terminal is not initialized; generating, by the franchise ASP server, a token corresponding to the request for initialization; generating, by the franchise ASP server, an initialization net key based on the generated token and a franchise identifier, and transmitting the generated initialization net key to the payment terminal; transmitting, by the payment terminal, the received initialization net key to a franchise representative terminal; processing, by the franchise ASP server, the requested initialization of the payment terminal in conjunction with the smart safe for receiving the initialization net key from the franchise representative terminal having received the initialization net key; and transmitting, by the franchise ASP server, a result of the processed initialization to the payment terminal.

Also, the requesting of the initialization of the payment terminal may include transmitting, by the payment terminal, a terminal identification number of the payment terminal and a phone number of the payment terminal to the franchise ASP server, and the generating of the token corresponding to the request for initialization may include generating, by the franchise ASP server, a transaction identification number corresponding to the request for initialization, and adding ASP transaction information based on the generated transaction identification number.

Also, the transmitting of the initialization net key may include extracting, by the franchise representative terminal, the initialization net key from a QR code image generated by the payment terminal based on the initialization net key, or transmitting, by the payment terminal, the initialization net key to the franchise representative terminal through short-range wireless communication.

Also, the processing of the initialization of the payment terminal may include receiving, by the franchise ASP server, the token included in the initialization net key received from the franchise representative terminal, an identification number of the payment terminal, and a phone number of the payment terminal, determining whether the token is valid based on a valid processing time of the token, registering the payment terminal normally when the token is valid, and checking contract information corresponding to the received phone number of the payment terminal when the token is not valid, registering the payment terminal normally by determining that the payment terminal is the same as a contract representative terminal when there is contract information corresponding to the received phone number of the payment terminal, and not registering the payment terminal when there is no contract information corresponding to the received phone number of the payment terminal.

Also, the generating of the token corresponding to the payment amount and the payment-related information may include generating a transaction identification number corresponding to a request for payment, and adding ASP transaction information based on the generated transaction identification number.

Also, the transmitting of the net key for payment to the buyer terminal may include extracting, by the buyer terminal, the net key for payment from the QR code image generated by the payment terminal based on the net key for payment, or transmitting, by the payment terminal, the net key for payment to the buyer terminal through short-range wireless communication.

### Advantageous Effects

In the conventional system, a client may input and manipulate identification (ID), a password, personal information, and payment information, and therefore there are risks of security and anxiety for a user. A small-sized web site that cannot directly enter into a franchise agreement with a mobile communication company may use the system of the present invention, and therefore it is possible to provide safe and convenient authentication services, membership registration services, and payment services to a user without inputting ID or a password, personal information, and payment information.

The payment terminal 600 application of the seller according to the present invention and the franchise ASP system may implement the net key and smart safe services in conjunction with each other, and use payment information stored in the smart safe, and therefore payment information such as card information is not required in the payment terminal 600 of the seller, whereby simple and safe payment may be performed. In addition, a path for payment is simplified, and therefore a payment fee is reduced, which is beneficial to both the seller and the buyer.

### DESCRIPTION OF DRAWINGS

FIG. 1 illustrates a configuration of a net key for online payment and a smart safe system;

FIG. 2 illustrates a configuration of a net key for offline payment and a smart safe system;

FIG. 3 is a configuration diagram illustrating a payment terminal according to an embodiment of the present invention;

FIG. 4 is a functional block diagram illustrating a smart safe server according to an embodiment of the present invention;

FIG. 5 is a block diagram illustrating a franchise Application Service Provider (ASP) server according to an embodiment of the present invention;

FIG. 6 is a functional block diagram of a web server according to an embodiment of the present invention;

FIG. 7 is a flowchart illustrating a case in which a payment application is executed in a payment terminal of a seller according to an embodiment of the present invention;

FIG. 8 is a flowchart illustrating a payment process in an online shop according to an embodiment of the present invention;

FIG. 9 is a flowchart illustrating an initialization process of a payment terminal according to an embodiment of the present invention;

FIG. 10 is a flowchart illustrating a process of processing payment using a payment terminal according to an embodiment of the present invention;

FIG. 11 illustrates an initialization process screen of a payment terminal according to an embodiment of the present invention; and

FIG. 12 illustrates a payment process using a payment terminal according to an embodiment of the present invention.

### MODES OF THE INVENTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Hereinafter, preferred embodiments of the present invention will be described in detail with reference to the accompanying drawings.

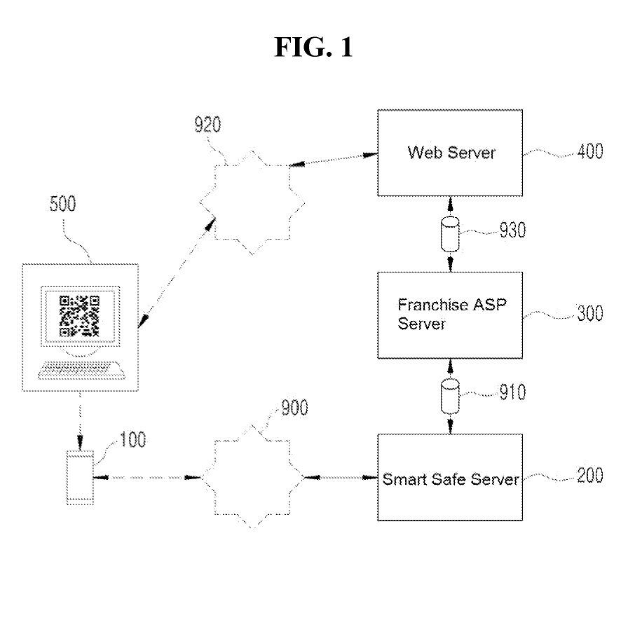

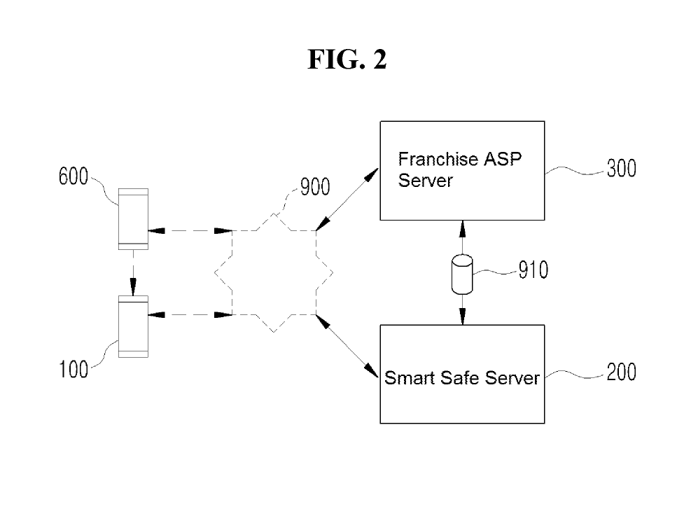

FIG. 1 illustrates a configuration of a net key for online payment and a smart safe system, and FIG. 2 illustrates a configuration of a net key for offline payment and a smart safe system.

A payment system (Application Service Provider (ASP) system) according to an embodiment of the present invention may include a buyer terminal 100, a smart safe server 200, a franchise ASP server 300, a web server 400, a client terminal 500 that displays a quick response (QR) code including a net key on a screen, and a payment terminal 600 of a seller. The above-described respective components may be connected with each other through a wired/wireless communication network, Virtual Private Networks (VPN) 900, 910, 920, and 930, or the like.

The net key includes a one-time token and identification (ID) information of a generator that generates the token, and a data type of the net key is a data type mutually agreed upon in such a manner that the franchise ASP server 300 that has generated the token and the smart safe server 200 that has received the net key from the mobile communication terminal 100 can separate the token and the ID information of the generator from the net key.

The token is generated in the franchise ASP server 300, and a validity time of the token may be set as a unique identifier in the franchise ASP server 300. The token is configured so as to be valid when recovered and processed by the franchise ASP server 300 that has generated the token within the set validity time.

The smart safe is a server that stores/manages personal authentication information of a subscriber for membership registration service and authentication service and payment information of the subscriber for payment services, and it is assumed that a use agreement for the purchased mobile communication terminal 100 and a smart safe service use agreement with a mobile communication company have been executed externally, and thus a payment application is installed in the purchased mobile communication terminal 100 and executed to transmit the type of net key that was agreed upon. In addition, the smart safe filters and receives only the type of net key that was agreed upon, and therefore no control command can be issued from the outside to the smart safe, and the smart safe is excellent for security.

Terms such as the token, the smart safe, and the like, which are defined considering the functions of the present invention, may be implemented differently depending on a user's and operator's intentions and practices. Therefore, the terms should be understood on the basis of the disclosure throughout the specification.

The buyer terminal 100 includes a payment application and a camera that can scan a QR code, and has a short-range wireless communication function such as Bluetooth or near field communication (NFC) to receive the net key and transmit the net key to the smart safe server 200.

An online payment method according to an embodiment of the present invention may include: the payment terminal 500 (client terminal) requesting payment from the web server 400; the web server 400 requesting a net key for payment based on payment-related information (site ID, payment amount information, and the like) from the franchise ASP server 300; the franchise ASP server 300 adding data to ASP transaction information 394; the franchise ASP server 300 generating a token and adding data to token information; the franchise ASP server 300 generating the net key for payment based on the generated token and a franchise identifier for identifying a franchise; and the franchise ASP server 300 transmitting the generated token and the net key for payment to the web server 400.

The online payment method may further include: the web server 400 receiving the token and the net key for payment in response to the request for the net key for payment from the franchise ASP server 300; the web server 400 adding information to a transaction information database; the web server 400 adding information to a token information database using the received token; the web server 400 generating a QR code image based on the received net key for payment; the web server 400 creating a screen including the QR code image; and the web server 400 transmitting the created screen to the payment terminal 500 (client terminal).

The online payment method may further include: the buyer terminal 100 extracting the net key for payment from the QR code image displayed on a display unit of the payment terminal 500 (client terminal) and transmitting the extracted net key to the smart safe server 200; the smart safe server 200 processing payment while communicating with the franchise ASP server 300 through a net key receiving function unit 210, an authentication function unit 220, and a payment function unit 230; and the franchise ASP server 300 updating the information of the token information database and the ASP transaction information.

The online payment method may further include: the web server 400 updating token information 492 and transaction information 493. In this instance, the franchise ASP server 300 and the web server 400 communicate in conjunction with each other.

The online payment method may further include: the web server 400 periodically confirming the token database (*information?) 492 in accordance with a token monitoring request of the payment terminal 500 (client terminal); and the web server 400 notifying the payment terminal 500 that the token has been completely processed when the token has been completely processed.

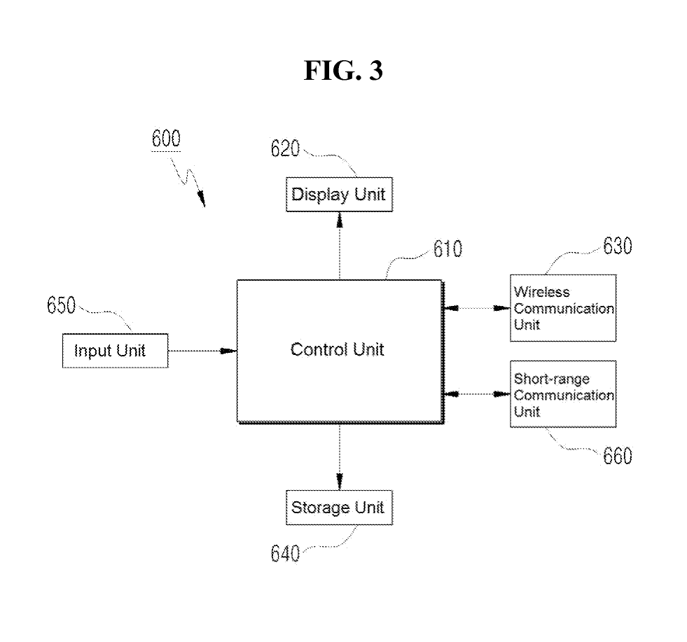

FIG. 3 is a configuration diagram illustrating a payment terminal 600 according to an embodiment of the present invention.

Referring to FIG. 3, the payment terminal 600 of a seller according to an embodiment of the present invention may include a control unit 610, a display unit 620, a wireless communication unit 630, a storage unit 640, an input unit 650, and a short-range communication unit 660.

The display unit 620 displays information under control of the control unit 610. The wireless communication unit 630 performs a communication function with the smart safe server 200 and the franchise ASP server 300 via a network 900 or the like. The storage unit 640 may be a Read Only Memory (ROM), a Universal Subscriber Identity Module (USIM), a non-volatile mobile memory, or the like, and is a recording medium in which payment applications and files required for the application as well as an operating system of a mobile communication terminal are stored. Here, the applications and files are read and executed by the control unit 610. The input unit 650 is an input means such as a keypad, a touch device, voice input using recognition technology, or the like, and transmits a user's input to the control unit 610. The short-range communication unit 600 may transmit the net key to the mobile communication terminal 100.

The payment terminal 600 may include a payment application and a recording medium in which the payment application is stored, and may further include a payment terminal initial setting means in which the application is driven by manipulation of the input unit 650 and the mobile communication terminal is used as the payment terminal, a payment request means that inputs a payment amount through manipulation of the input unit 650 and requests payment, and a token processing confirmation means that confirms a processing state of the corresponding token in the terminal initial setting means or the payment request means.

The payment terminal initial setting means confirms whether an initialization state of the terminal is stored in the storage unit 640 when the application is driven, and when initialization of the terminal is completed, moves to a charge amount input screen, or when initialization is not performed, performs initialization of the terminal and receives consent to use the terminal through manipulation of the input unit 650.

The initialization of the terminal may include requesting an initialization net key from the franchise ASP server 300 based on a terminal ID number and a phone number of a terminal to be initialized, extracting a token from the initialization net key upon receiving the initialization net key from the franchise ASP server 300, generating a QR code image using the received initialization net key, and displaying the QR code image on the display unit 620.

In the initialization of the payment terminal, a token processing means in which a contract representative terminal (franchise representative terminal) of the ASP contract information 391 scans the QR code image of the display unit 620 and receives the net key to process the token is performed, and then the token processing confirmation means is performed and an initialization completed state is stored in the storage unit 640 when the token has been processed.

The token processing confirmation means may transmit and receive the token to the franchise ASP server 300 by pushing an initialization (token confirmation) button displayed on the display unit 620 of the payment terminal 600 through manipulation of the input unit 650.

The token processing confirmation means may store a state in which the initialization of the terminal is completed in the storage unit 640 when the token has been processed in the franchise ASP server 300, and move to the next screen.

The token processing confirmation means may enable a message indicating that the token is unprocessed to be displayed on the display unit 620 of the payment terminal 600 when a response for a token processing state received from the franchise ASP server 300 is unprocessed.

The payment request means may input the payment amount through external signals such as Bluetooth or the manipulation of the input unit 650 such as a keypad, a touch pad, voice input using voice recognition, or the like.

The payment request means may perform a net key requesting operation of requesting the net key for payment from the franchise ASP server 300 based on the payment amount, number of monthly installments, and a terminal ID number which are input to the payment terminal 600, a token extraction operation of extracting a token from the net key upon receiving the net key from the franchise ASP server 300, a QR code image generating operation of generating the QR code image using the received net key for payment, and a QR code displaying operation of displaying the QR code image on the display unit 620.

The payment request means may perform the net key requesting operation of requesting the net key for payment from the franchise ASP server 300 based on the payment amount, number of monthly installments, and a terminal ID number which are input to the payment terminal 600 and the token extraction operation of extracting a token from the net key upon receiving the net key from the franchise ASP server 300, and transmit and receive the received net key through the short-range communication unit 660.

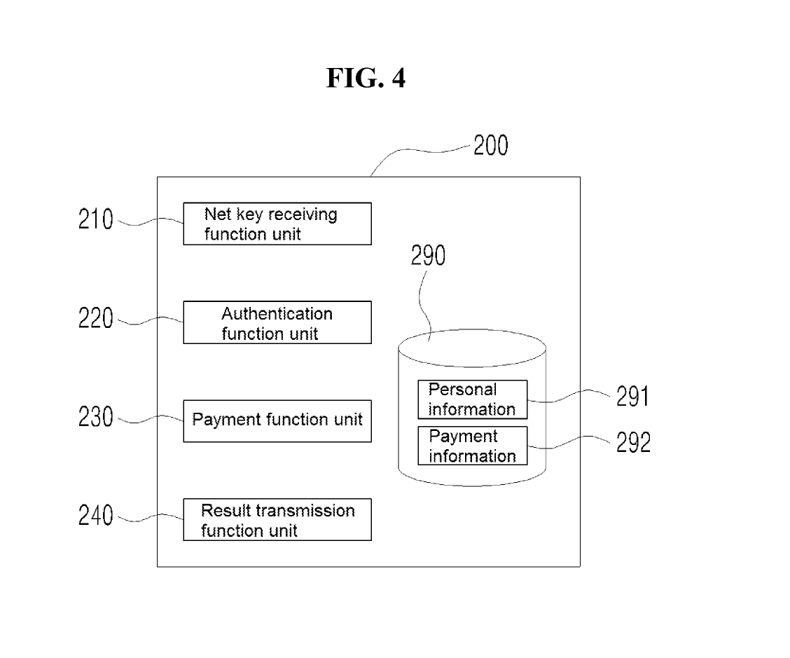

FIG. 4 is a functional block diagram illustrating a smart safe server 200 according to an embodiment of the present invention.

Referring to FIG. 4, the smart safe server 200 according to an embodiment of the present invention may include a net key receiving function unit 210, an authentication function unit 220, a payment function unit 230, a result transmission function unit 240, and a database 290 that stores and manages personal information 291 and payment information 292.

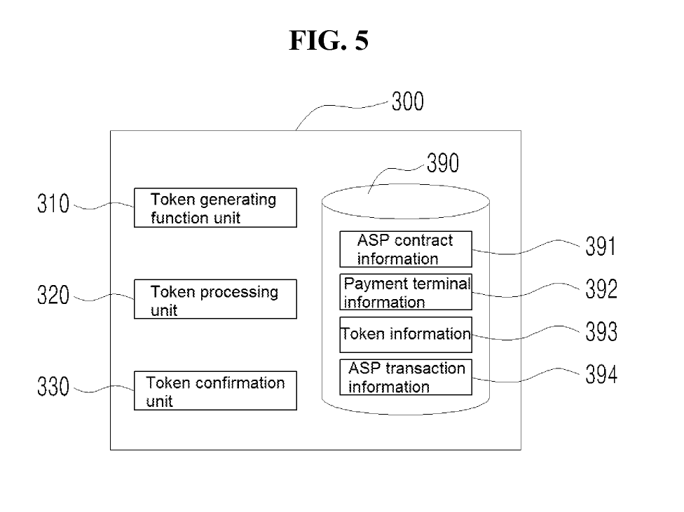

FIG. 5 is a block diagram illustrating a franchise ASP server 300 according to an embodiment of the present invention.

Referring to FIG. 5, the franchise ASP server 300 according to an embodiment of the present invention may include a token generating function unit 310, a token processing unit 320, a token confirmation unit 330, and a database 390 that stores/manages ASP contract information 391, payment terminal information 392, token information 393, ASP transaction information 394, and the like.

Upon receiving a request for a net key for payment, the token generating function unit 310 may generate a token based on transaction-related information included in the request, and generate the net key based on the generated token and a franchise identifier.

The token processing unit 320 may process the generated token in conjunction with a smart safe that has received the net key.

The token confirmation unit 330 may receive a confirmation request of the token from the payment terminal and confirm whether the token has been processed.

A seller enters into a franchise server use agreement with a franchise ASP company, and stores the ASP contract information 391 in the database 390 of the franchise ASP server 300. The ASP contract information 391 may include a corporation number for identifying a business, a unique ASP ID using a business number as a key value, a store number, a business name, an ASP classification for classifying online and offline payment, a phone number of a contract representative, account information of a contractor for payment settlement, website URL information of the contractor, and the like. The website URL information is required information in a case in which the ASP classification is online.

When requesting the net key for initialization of the terminal, the franchise ASP server 300 may perform a process of creating ASP transaction information in such a manner as to receive an ID number of the payment terminal, generate a unique transaction ID number, and add information to the ASP transaction information 394 using the generated transaction ID number as a key value.

When requesting the net key for initialization of the terminal, the franchise ASP server 300 may perform a process of creating token information in such a manner as to generate a unique token and add data to the token information using the generated token as the key value.

The ASP transaction information 394 may include a transaction ID number, an ID number of the payment terminal, a processing request date, a processing classification, a charge amount, a number of monthly installments, a phone number of a token processing terminal, a settlement date, and the like.

When requesting the net key for initialization of the payment terminal, the franchise ASP server 300 may register the transaction ID number, the ID number of the payment terminal, the processing request date, and data of the processing classification. The token information 393 may include a token, a transaction ID number, a token generation time, and a token processing time.

When requesting the net key for initialization of the payment terminal, the franchise ASP server 300 may register a token, the transaction ID number, and data of the token generation time in the process of creating token information.

The franchise ASP server 300 may include (*perform?) an operation of acquiring a transaction ID number coinciding with the token from the token information 393 by receiving a token and a phone number from the smart safe server 200, an operation of acquiring processing classification with which the transaction ID number coincides from the ASP transaction information 394 using the acquired transaction ID number as a key value, an operation of updating a phone number of the token processing terminal of the ASP transaction information 394 as the received phone number when the acquired processing classification is terminal setting, and an operation of updating a token processing time of the token information 393 as a system time.

In the initialization of the payment terminal, the franchise ASP server 300 may perform a parameter receiving operation of receiving a token, a terminal ID number, and a phone number, an operation of checking a transaction ID number and a token processing time from the token information 393 using the received token as a key value, an operation of determining that the token has been processed when the token processing time is a valid value and checking a token processing phone number from the ASP transaction information 394 using the transaction ID number as the key value, an operation of checking an ASP ID number and a store number from the ASP contract information 391 using the checked phone number as the key value, registering the ASP ID number and the store number in the payment terminal information 392 using the terminal ID number that is the parameter as the key value, and responding to (*notifying?) the payment terminal 600 of the seller that the token processing of the initialization of the terminal has been completed.

In the initialization of the payment terminal, the franchise ASP server 300 may perform a parameter receiving operation of receiving a token, a terminal ID number, and a phone number, an operation of checking a transaction ID number and a token processing time from the token information 393 using the received token as a key value, an operation of checking the ASP ID number and the store number which coincide with a phone number of a contract representative by checking the ASP contract information 391 using the received phone number as the key value when the token processing time is not a valid value, an operation of determining that the mobile communication terminal 100 using the phone number of the contract representative is used as the payment terminal 100 when coinciding information is located, and registering the ASP ID number, the phone number, and the store number in the payment terminal information 392 using the terminal ID number that is the parameter as the key value, and an operation of responding to (*notifying?) the payment terminal 600 of the seller that the registration process of the payment terminal information 392 has been completed.

In the initialization of the payment terminal, the franchise ASP server 300 may perform a parameter receiving operation of receiving a token, a terminal ID number, and a phone number, an operation of checking a transaction ID number and a token processing time from the token information 393 using the received token as a key value, an operation of checking the ASP ID number and the store number which coincide with a phone number of a contract representative by checking the ASP contract information 391 using the received phone number as the key value when the token processing time is not a valid value, and an operation of determining that the token is unprocessed when coinciding information is not located and notifying the payment terminal 600 of the seller that the token is unprocessed.

Upon receiving a request for the net key for payment, the franchise ASP server 300 may generate a token based on transaction-related information included in the request, and generate the net key for payment based on the generated token and the franchise ID.

The franchise ASP server 300 in the generating of the net key for payment may perform an operation of receiving an ID number of the payment terminal of the seller, a payment amount, and a number of monthly installments as parameters, and determining whether the payment terminal is registered by checking the payment terminal information 392 using the ID number of the payment terminal 600 as the key value.

When generating the net key for payment, the franchise ASP server 300 may perform a process of creating ASP transaction information in such a manner as to generate a unique transaction ID number and add information to the ASP transaction information 394 using the generated transaction ID number as the key value.

When generating the net key for payment, the franchise ASP server 300 may perform a process of creating token information in such a manner as to generate a unique token and add information to the token information 393 using the generated token as the key value.

When generating the net key for payment, the franchise ASP server 300 may register a transaction ID number, a payment terminal ID number, a processing request date, a processing classification, a charge amount, data on a number of monthly installments, and the like in the process of creating the ASP transaction information.

When generating the net key for payment, the franchise ASP server 300 may register the token, the transaction ID number, data of the token generation time, and the like in the process of creating the token information.

The franchise ASP server 300 may process the generated token in conjunction with the smart safe that has received the net key for payment. In this instance, the franchise ASP server 300 may perform an operation of acquiring a transaction ID number coinciding with the token from the token information 393 by receiving a token and a phone number from the smart safe server 200, an operation of acquiring a processing classification with which the transaction ID number coincides from the ASP transaction information 394 using the acquired transaction ID number as a key value, an operation of updating a phone number of the token processing terminal of the ASP transaction information 394 as the received phone number when the acquired processing classification is for payment, and an operation of updating a token processing time of the token information 393 as a system time.

The franchise ASP server 300 may receive a confirmation request of the token from the payment terminal to determine whether the token has been processed. In this instance, the franchise ASP server 300 may perform a parameter receiving operation of receiving a token, an operation of checking a token processing time from the token information 393 using the received token as the key value, and an operation of determining that the token has been processed when the token processing time is a valid value, and responding to (*notifying?) the payment terminal 600 of the seller that the token has been processed.

In addition, the franchise ASP server 300 may perform a parameter receiving operation of receiving a token, an operation of checking a token processing time from the token information 393 using the received token as the key value, and an operation of determining that the token is unprocessed when the token processing time is not a valid value, and responding to (*notifying?) the payment terminal 600 that the token is unprocessed.

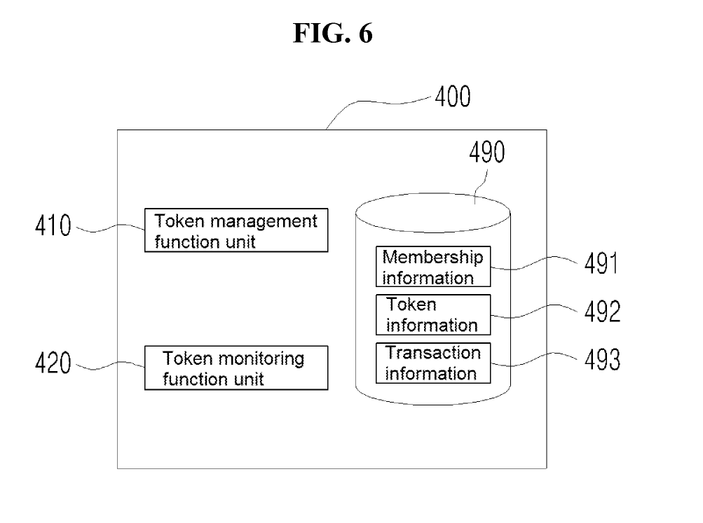

FIG. 6 is a functional block diagram of a web server according to an embodiment of the present invention.

Referring to FIG. 6, the web server 400 according to an embodiment of the present invention may include a token management function unit 410, a token monitoring function unit 420, and a database 490 that stores/manages membership information 491, token information 492, and transaction information 493.

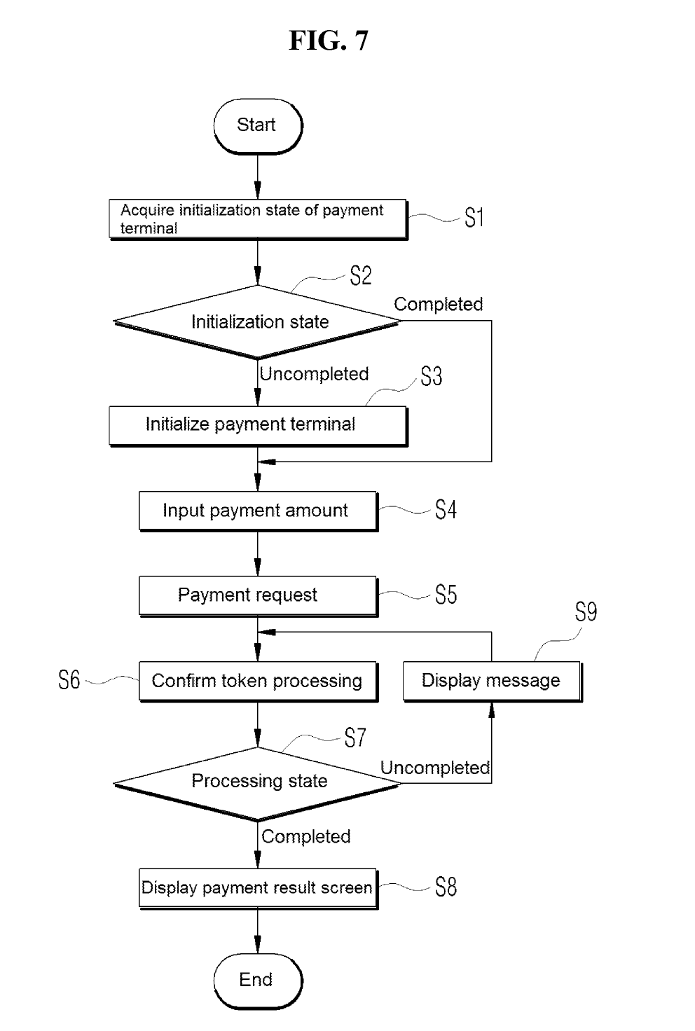

FIG. 7 is a flowchart illustrating a case in which a payment application is executed in a payment terminal of a seller according to an embodiment of the present invention.

Referring to FIG. 7, in operation S1, the payment terminal 600 acquires an initialization state when an application is executed. In this instance, when the initialization is not completed, the payment terminal performs initialization in operation S3.

The payment terminal 600 receives a payment amount in operation S4, and requests payment in operation S5. The payment terminal 600 confirms token processing in operation S6, and displays a payment result on a screen in operation S8 when the token processing is completed. When the token processing is not completed, the payment terminal 600 displays a message indicating that the token is unprocessed on the display unit 650 (*620?).

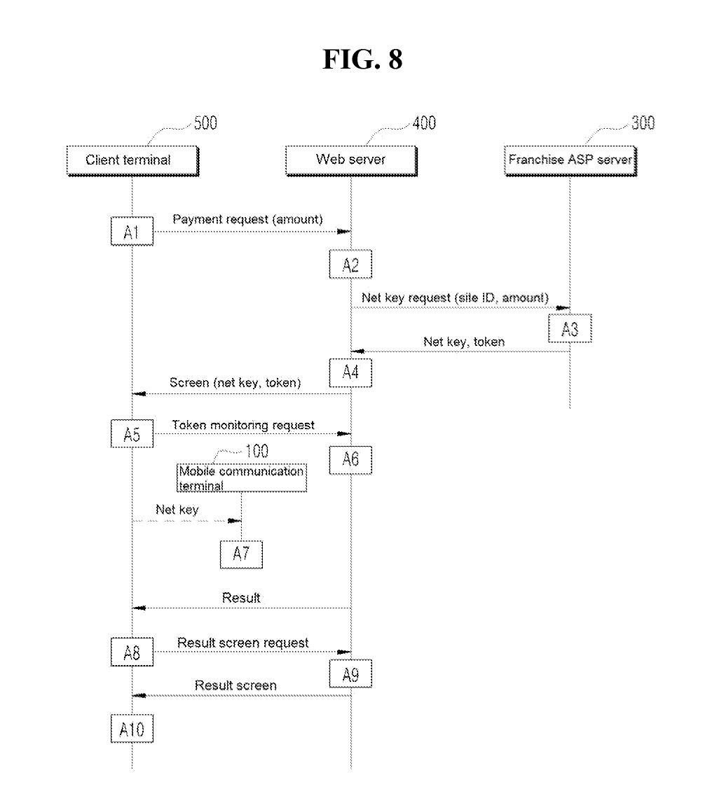

FIG. 8 is a flowchart illustrating a payment process in an online shop according to an embodiment of the present invention.

Referring to FIG. 8, when payment (or authentication and membership registration) is required in a web browser of the payment (client) terminal 500, payment is requested from the web server 400 via a network 920 by manipulating the input unit in operation A1.

The web server 400 requests a net key for payment from the franchise ASP server 300 based on received payment amount information and site ID in operation A2. The franchise ASP server generates a token in the token generating function unit 310, generates the net key for payment in which the token and the franchise ID are combined, and notifies the web server of the generated token and net key for payment in operation A3. In this instance, the franchise ASP server 300 adds data to the ASP transaction information and the token information 393. The web server 400 generates a QR code image using the received net key for payment, and generates a screen including the QR code image to notify the payment (client) terminal 500 of the generated screen in operation A4. In this instance, the web server 400 adds data to the transaction information 493 and the token information 492.

The payment (client) terminal 500 displays the screen including the QR code image, and requests token processing monitoring from the web server 400 with respect to the corresponding token in operation A5. The token monitoring function unit 420 of the web server 400 monitors the token information 492 at a fixed time interval, and notifies the payment (client) terminal 500 that the token has been processed when the token has been processed in operation A6. A user may receive the net key using the QR code by manipulating the input unit of the terminal 100, or receive the net key for payment through short-range communication. The received net key for payment is transmitted to the smart safe server 200, and the smart safe server 200, the franchise ASP server 300, and the web server 400 communicate with each other and process the token for payment system conjunction between the systems in operation A7. Upon notifying the payment (client) terminal 500 that the token has been processed in operation A6, the payment terminal 500 requests a token processing result screen from the web server 400 in operation A8. The web server generates the token processing result screen and responds to the payment terminal 500 in operation A9. The payment terminal 500 displays the received result screen in operation A10.

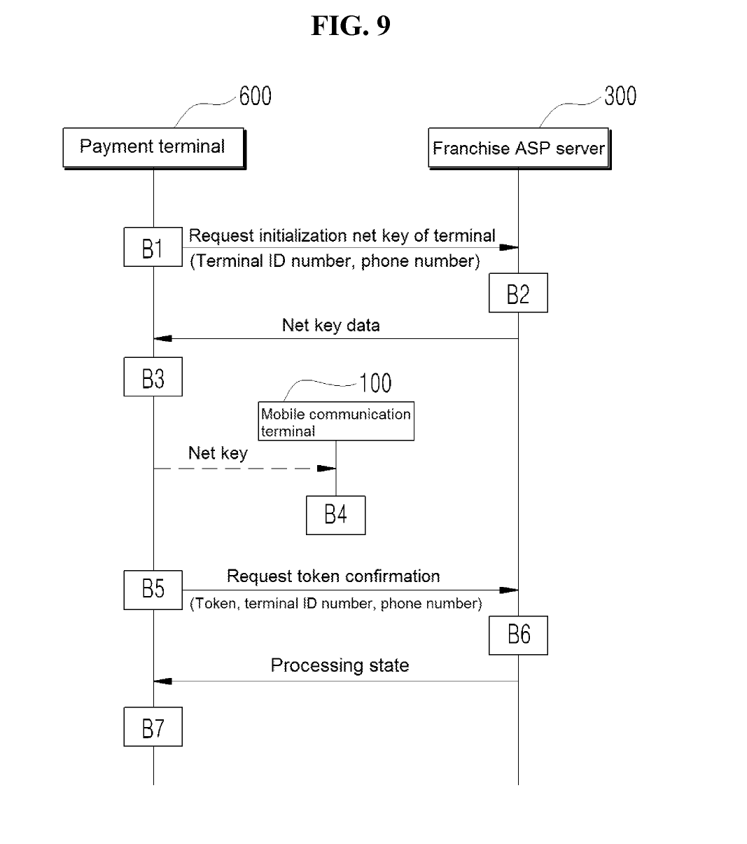

FIG. 9 is a flowchart illustrating an initialization process of a payment terminal 600 according to an embodiment of the present invention.

Referring to FIG. 9, the payment terminal 600 (for example, a smartphone) may confirm whether terminal initialization state information is stored in the storage unit 640 when a payment application is driven, and request an initialization net key of the terminal from the franchise ASP server 300 as well as consent to use the terminal through manipulation of the input unit 650 when the initialization is not performed in operation B1. The franchise ASP server 300 receives an ID number and a phone number of the payment terminal, generates a unique transaction ID number, and adds data to the ASP transaction information 394 using the generated transaction ID number as the key value. Next, the unique token is generated, data is added to the token information 393 using the generated token as the key value, and the initialization net key in which the generated token and the franchise ID are combined is generated. Next, the initialization net key is provided as a response to the payment terminal 600 in operation B2. The payment terminal extracts the token from the received initialization net key, generates the QR code image using the initialization net key, and displays the generated QR code image on the display unit 620 in operation B3. A buyer receives the initialization net key from the QR code by manipulating the input unit of the terminal 100 or receives the initialization net key through short-range communication, and transmits the received initialization net key to the smart safe server 200. The smart safe server 200 and the franchise ASP server 300 communicate with each other, and process the token for initialization of the payment terminal 600 through conjunction between the systems in operation B4. The payment terminal 600 requests a token processing confirmation from the franchise ASP server 3000 based on the token, the phone number, and the terminal ID number in operation B5. The franchise ASP server 300 confirms whether the token has been processed by checking the ASP contract information database, notifies the payment terminal 600 that the token is unprocessed when the token is unprocessed, and registers the payment terminal 600 using the terminal ID number as the key value in the payment terminal information database when the token has been processed. Next, the franchise ASP server 300 notifies the payment terminal 600 that the token has been processed in operation B6. The payment mobile communication terminal 600 displays a message indicating that the token is unprocessed on the display unit 620 when the received token processing state is unprocessed, stores a terminal initialization completion state in the storage unit 640 when the token has been processed, and moves to the next screen in operation B7.

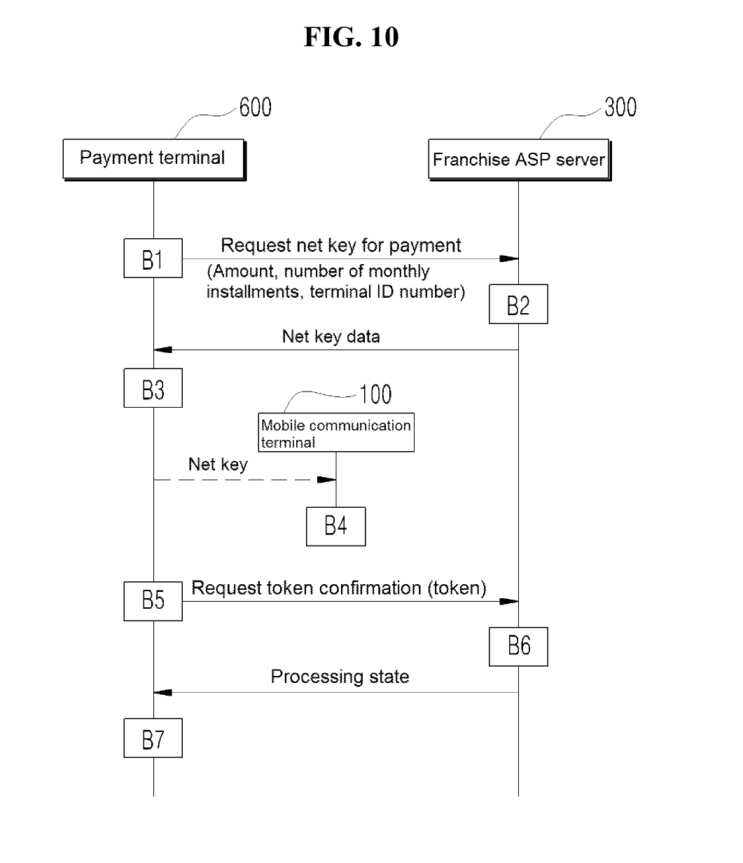

FIG. 10 is a flowchart illustrating a process of processing payment using a payment terminal according to an embodiment of the present invention.

Referring to FIG. 10, the payment terminal 600 receives a payment amount, and requests payment by transmitting the payment amount and payment-related information to the franchise ASP server 300 in operation B1. In this instance, the request for payment may be a request for a net key for payment. The franchise ASP server 300 may receive the payment amount and the payment-related information (number of monthly installments, payment terminal ID number, and the like), generate a unique transaction ID number, and then add data to the ASP transaction information 394 using the generated transaction number as the key value (creating ASP transaction information).

The franchise ASP server 300 generates a unique token, adds data to the token information 393 using the generated token as the key value (creating token information), and generates the net key for payment in which the generated token and the franchise ID are combined. The franchise ASP server 300 transmits the net key for payment to the payment terminal 600 in operation B2. The payment terminal 600 transmits the received net key for payment to a buyer terminal. In this instance, the payment terminal 600 may generate a QR code image based on the received net key for payment. The payment terminal 600 displays the generated QR code image on the display unit 620 in operation B3. The buyer terminal extracts the net key for payment by reading the QR code or receiving the net key for payment through short-range communication, and transmits the received net key for payment to the smart safe server 200. The smart safe server 200 and the franchise ASP server communicate with each other, and process the requested payment (token for payment) through conjunction between the systems in operation B4.

The payment terminal 600 may request a token processing confirmation from the franchise ASP server 300 in operation B50. The franchise ASP server 300 confirms whether the token has been processed by checking the token information 393 using the received token. The franchise ASP server 300 may notify the payment terminal 600 that the token is unprocessed when the token is unprocessed, and notify the payment mobile communication terminal 600 that the token has been processed when the token has been processed in operation B6. The payment mobile communication terminal 600 displays a message indicating a token unprocessed state on the display unit 620 when the received token processing state is unprocessed, and moves to a payment result screen (processing completion screen) when the token has been processed in operation B7.

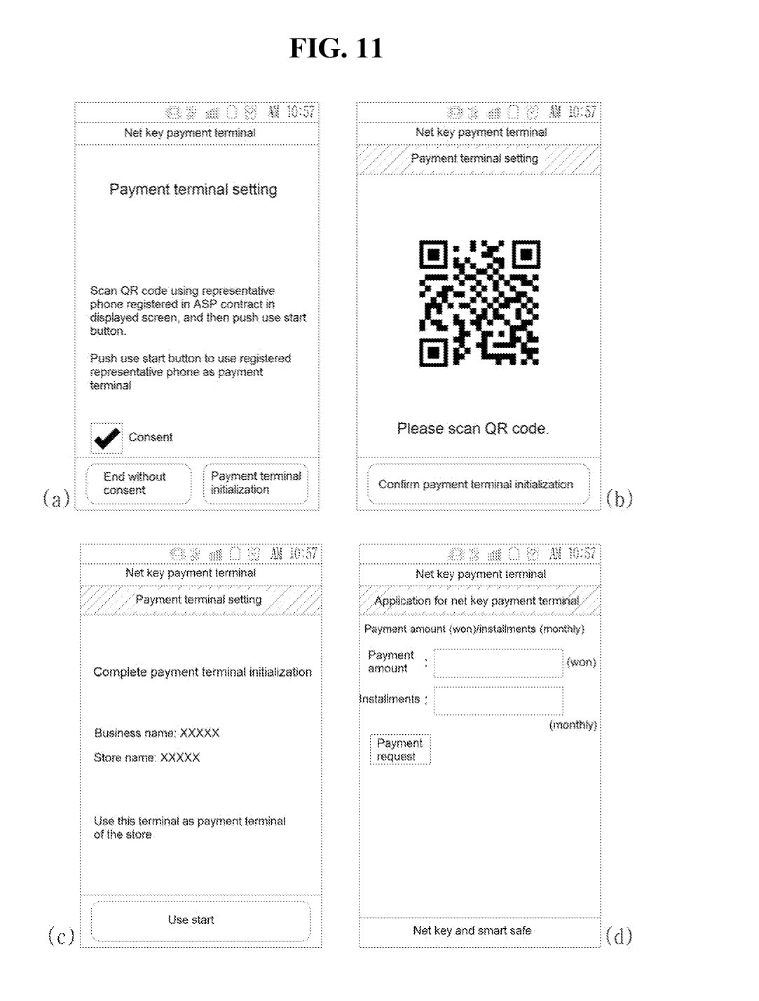

FIG. 11 illustrates an initialization process screen of a payment terminal according to an embodiment of the present invention.

(a) of FIG. 11 is a screen displayed on the display unit 620 of the payment terminal 600 when the payment terminal is not initialized.

In (a) of FIG. 11, when initialization of the payment terminal is selected through manipulation of the input unit 650, the payment terminal 600 requests the initialization net key from the franchise ASP server 300.

The franchise ASP server 300 performs the operation B2 described in FIG. 9. (b) of FIG. 11 is a screen in which the payment terminal receives the initialization net key and generates and displays the QR code image.

(c) of FIG. 11 is a screen executed when the initialization is completed. (d) of FIG. 11 is a screen in which use start is selected through manipulation of the input unit 650 and then a payment amount is input.

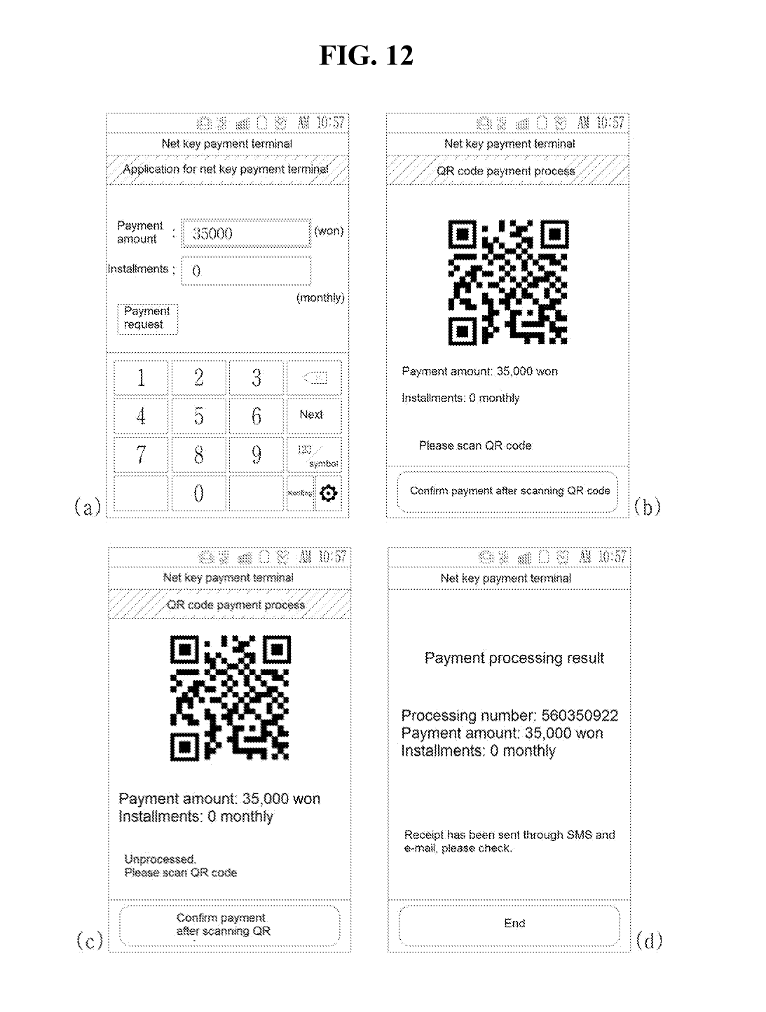

FIG. 12 illustrates a payment process using a payment terminal according to an embodiment of the present invention.

(a) of FIG. 12 is a screen in which a payment amount is input (operation B1 of FIG. 10).

In (a) of FIG. 12, when payment request is selected through manipulation of the input unit 650, the payment terminal 600 requests the net key for payment from the franchise ASP server 300, receives the net key for payment from the franchise ASP server, and generates and displays the QR code image. (b) of FIG. 12 is a screen showing the above-described process.

When payment confirmation is selected, the payment terminal 600 requests payment confirmation from the franchise ASP server 300, and displays a message indicating an unprocessed state when an unprocessed state is received. (c) of FIG. 12 is a screen showing the above-described process.

The mobile communication terminal 100 of the seller receives the net key for payment, and processes the token for payment. Next, the payment terminal 600 selects payment confirmation to request payment confirmation from the franchise ASP server 300. (d) of FIG. 12 is a screen indicating when payment has been completed when a response state is payment completion.

According to the embodiments of the present invention, the mobile communication terminal 100 and the payment terminal 600 may be a normal smartphone, a tablet PC, or the like. The application is stored in the storage unit, and is executed under control of the control unit.

According to the embodiments of the present invention, the smart safe server 200, the franchise ASP server 300, and the web server 400 have a server operating system as a normal server system, and applications obtained by programming the processing and steps are stored in the storage unit that is a computer-readable recording medium and loaded and executed through control of the control unit.

The database 290 of the smart safe server 200, the database 390 of the franchise ASP server 300, and the database 490 of the web server 400 may be a normal database server, and may be implemented by applications which manage creation, deletion, and updating of various information databases.

In this specification, exemplary embodiments of the present invention have been classified as the first, second and third exemplary embodiments and described for conciseness. However, respective steps or functions of an exemplary embodiment may be combined with those of another exemplary embodiment to implement still another exemplary embodiment of the present invention.

While the invention has been shown and described with reference to certain exemplary embodiments thereof, it will be understood by those skilled in the art that various changes in form and details may be made therein without departing from the spirit and scope of the invention as defined by the appended claims.

1. A franchise Application Service Provider (ASP) server comprising:
a token generating function unit that generates a token on the basis of transaction-related information included in a payment request upon receiving the payment request from a payment terminal, and generates a net key for payment on the basis of the generated token and a franchise identifier;
a token processing unit that processes the generated token in conjunction with a smart safe for receiving the net key for payment from a buyer terminal having received the net key for payment; and
a token confirmation unit that receives a confirmation request of the token from the payment terminal and confirms whether the token has been processed.

2. The franchise ASP server of claim 1, further comprising:
a database that stores at least one of ASP contract information, payment terminal information, token information, and ASP transaction information.

3. The franchise ASP server of claim 1, wherein the net key for payment is transmitted to the payment terminal from the franchise ASP server, and is converted into a quick response (QR) code by the payment terminal.

4. The franchise ASP server of claim 3, wherein the payment terminal is extracted by the buyer terminal from the QR code, and transmitted to the smart safe.

5. The franchise ASP server of claim 1, wherein the smart safe stores personal authentication information and payment information of a buyer.

6. An online payment method comprising:
requesting, by a payment terminal, payment from a web server;
requesting, by the web server, a net key for payment based on a site identifier and payment information from a franchise ASP server;
generating, by the franchise ASP server, a token corresponding to the request for payment;
generating, by the franchise ASP server, the net key for payment based on the generated token and a franchise identifier;
transmitting, by the franchise ASP server, the generated token and the net key for payment to the web server;
generating, by the web server, a QR code image based on the received net key for payment; and
creating, by the web server, a screen including the QR code image, and transmitting the created screen to a client terminal.

7. The online payment method of claim 6, further comprising:
extracting, by a buyer terminal, the net key for payment from the QR code image displayed on the payment terminal, and transmitting the extracted net key for payment to a smart safe; and
processing, by the smart safe, the requested payment in conjunction with the franchise ASP server.

8. The online payment method of claim 6, further comprising:
periodically confirming, by the web server, whether the token has been processed according to a token monitoring request of the payment terminal; and
notifying, by the web server, the payment terminal that the token has been completely processed when the token has been completely processed.

9. The online payment method of claim 6, wherein the smart safe stores personal authentication information and payment information of a buyer.

10. The online payment method of claim 6, wherein a predetermined validity time of the token is designated, and the token is valid only when the token is processed within the predetermined validity time.

11. An offline payment method comprising:
transmitting, by a payment terminal, a payment amount and payment-related information to a franchise ASP server to request payment;
generating, by the franchise ASP server, a token corresponding to the payment amount and the payment-related information;
generating, by the franchise ASP server, a net key for payment based on the generated token and a franchise identifier, and transmitting the net key for payment to the payment terminal;
transmitting, by the payment terminal, the received net key for payment to a buyer terminal;
processing, by the franchise ASP server, the requested payment in conjunction with a smart safe for receiving the net key for payment from the buyer terminal having received the net key for payment; and
transmitting, by the franchise ASP server, a result of the processed payment to the payment terminal.

12. The offline payment method of claim 11, further comprising:
requesting, by the payment terminal, initialization of the payment terminal from the franchise ASP server when the payment terminal is not initialized;
generating, by the franchise ASP server, a token corresponding to the request for initialization;
generating, by the franchise ASP server, an initialization net key based on the generated token and a franchise identifier, and transmitting the generated initialization net key to the payment terminal;
transmitting, by the payment terminal, the received initialization net key to a franchise representative terminal;
processing, by the franchise ASP server, the requested initialization of the payment terminal in conjunction with the smart safe for receiving the initialization net key from the franchise representative terminal having received the initialization net key; and
transmitting, by the franchise ASP server, a result of the processed initialization to the payment terminal.

13. The offline payment method of claim 12, wherein
the requesting of the initialization of the payment terminal includes transmitting, by the payment terminal, a terminal identification number of the payment terminal and a phone number of the payment terminal to the franchise ASP server, and
the generating of the token corresponding to the request for initialization includes generating, by the franchise ASP server, a transaction identification number corresponding to the request for initialization, and adding ASP transaction information based on the generated transaction identification number.

14. The offline payment method of claim 12, wherein the transmitting of the initialization net key includes
extracting, by the franchise representative terminal, the initialization net key from a QR code image generated by the payment terminal based on the initialization net key, or
transmitting, by the payment terminal, the initialization net key to the franchise representative terminal through short-range wireless communication.

15. The offline payment method of claim 12, wherein the processing of the initialization of the payment terminal includes
receiving, by the franchise ASP server, the token included in the initialization net key received from the franchise representative terminal, an identification number of the payment terminal, and a phone number of the payment terminal,
determining whether the token is valid based on a valid processing time of the token,
registering the payment terminal normally when the token is valid, and
checking contract information corresponding to the received phone number of the payment terminal when the token is not valid, registering the payment terminal normally by determining that the payment terminal is the same as a contract representative terminal when there is contract information corresponding to the received phone number of the payment terminal, and not registering the payment terminal when there is no contract information corresponding to the received phone number of the payment terminal.

16. The offline payment method of claim 11, wherein the generating of the token corresponding to the payment amount and the payment-related information includes
generating a transaction identification number corresponding to a request for payment, and adding ASP transaction information based on the generated transaction identification number.

17. The offline payment method of claim 11, wherein the transmitting of the net key for payment to the buyer terminal includes
extracting, by the buyer terminal, the net key for payment from the QR code image generated by the payment terminal based on the net key for payment, or
transmitting, by the payment terminal, the net key for payment to the buyer terminal through short-range wireless communication.
